(19) United States
(12) Patent Application Publication
(10) Pub. No.: US 2026/0095939 A1
(43) Pub. Date: Apr. 2, 2026

(54) CHANNEL ACCESS PRIORITY CLASS DESIGN FOR SIDELINK UNLICENSED

(71) Applicant: Apple Inc., Cupertino, CA (US)

(72) Inventors: Peng Cheng, Beijing (CN); Alexander Sirotkin, Hod Hasharon (IL); Chunxuan Ye, San Diego, CA (US); Fangli Xu, Beijing (CN); Haijing Hu, Los Gatos, CA (US); Naveen Kumar R. Palle Venkata, San Diego, CA (US); Ping-Heng Kuo, London (GB); Ralf Rossbach, Munich (DE); Yuqin Chen, Beijing (CN); Zhibin Wu, Los Altos, CA (US); Huaning Niu, San Jose, CA (US)

(21) Appl. No.: 19/111,847

(22) PCT Filed: Sep. 13, 2023
(86) PCT No.: PCT/US2023/032604

§ 371 Date: Mar. 14, 2025

Related U.S. Application Data
(60) Provisional application No. 63/407,580, filed on Sep. 16, 2022.

(51) Int. Cl. H04W 74/0808; H04W 92/18

(52) U.S. Cl. CPC H04W 74/0808; H04W 92/18

(57) ABSTRACT

This disclosure relates to a method to be performed by a first user equipment (UE). The method includes determining, by the first UE, a channel access priority class (CAPC) for a transmission to a second UE over a sidelink interface, and performing a listen-before-talk procedure on the sidelink interface based on the determined CAPC.

### CROSS-REFERENCE TO RELATED APPLICATIONS

The present application claims priority to U.S. Provisional Application No. 63/407,580, filed on Sep. 16, 2022, titled “CHANNEL ACCESS PRIORITY CLASS DESIGN FOR SIDELINK UNLICENSED,” which is incorporated herein by reference in its entirety.

### BACKGROUND

Wireless communication networks provide integrated communication platforms and telecommunication services to wireless user devices. Example telecommunication services include telephony, data (e.g., voice, audio, and/or video data), messaging, internet-access, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

In some wireless communications networks, a user equipment (UE) may communicate with another UE directly (e.g., without a radio access network as an intermediary) using what is referred to as sidelink communication. During sidelink communication, a transmitting UE determines a subset of available sidelink resources to communicate with a receiving UE based on a resource allocation scheme. Existing protocols support sidelink communication using two different resource allocation schemes. In a first scheme, referred to as mode 1 resource allocation (“mode 1”), the sidelink resources are allocated by an access node for in-coverage UEs. In a second scheme, referred to as mode 2 resource allocation (“mode 2”), the transmitting UE selects the sidelink resources from the available sidelink resources (e.g., the sidelink resource pool).

### SUMMARY

The present disclosure describes techniques for Channel Access Priority Class (CAPC) selection for transmissions over sidelink unlicensed. The disclosed techniques are designed to account for features specific to sidelink, and therefore, are different than existing CAPC selection mechanisms (e.g., for interfaces other than sidelink). In some examples, a new mapping is defined that relates a PC5 5QI (PQI) for a sidelink transmission to a CAPC for the transmission. Other mappings to facilitate CAPC selection for sidelink are also defined, including mappings between sidelink logical channel (SL-LCH) priority and CAPC, and between L1 priority and CAPC. Various rules for CAPC selection based on the logical channel for a sidelink transmission, the sidelink bearer (e.g., SL-SRB or SL-DRB) for the transmission, and/or a type of data included in the transmission are also defined.

In general, in a first aspect, a method to be performed by a first user equipment (UE) includes determining, by the first UE, a CAPC for a transmission to a second UE over a sidelink interface, and performing a listen-before-talk procedure on the sidelink interface based on the determined CAPC.

In general, in a second aspect combinable with the first aspect, determining the CAPC for the transmission includes: determining a PC5 5QI (PQI) for the transmission to the second UE over the sidelink interface, and determining the CAPC for the transmission based on the PQI for the transmission and a mapping between PQIs and CAPCs.

In general, in a third aspect combinable with any of the first or second aspects, the PQI for the transmission is determined based on a quality of service (QoS) associated with the transmission.

In general, in a fourth aspect combinable with any of the first through third aspects, the transmission is associated with a non-standardized QoS, and determining the PQI for the transmission includes: determining a standardized QoS based on the non-standardized QoS, and using a PQI associated with the standardized QoS as the PQI for the transmission.

In general, in a fifth aspect combinable with any of the first through fourth aspects, determining the CAPC for the transmission includes: determining a sidelink logical channel for the transmission to the second UE over the sidelink interface; and determining the CAPC for the transmission based on the sidelink logical channel for the transmission and a mapping between sidelink logical channels and CAPCs.

In general, in a sixth aspect combinable with any of the first through fifth aspects, the mapping associates a physical sidelink feedback channel (PSFCH) or a physical sidelink control channel (PSCCH) with a highest priority CAPC.

In general, in a seventh aspect combinable with any of the first through sixth aspects, determining the CAPC for the transmission includes: determining a type of data included in the transmission to the second UE over the sidelink interface, and determining the CAPC for the transmission based on the type of data included in the transmission and a mapping between types of data transmissions and CAPCs.

In general, in an eighth aspect combinable with any of the first through seventh aspects, the mapping associates a sidelink synchronization signal block (SL-SSB) with a highest priority CAPC.

In general, in a ninth aspect combinable with any of the first through eighth aspects, the mapping associates at least one type of medium access control (MAC) control element (CE) with a highest priority CAPC or a lowest priority CAPC.

In general, in a tenth aspect combinable with any of the first through ninth aspects, the mapping associates a padding buffer status report (BFR) with a lowest priority CAPC.

In general, in an eleventh aspect combinable with any of the first through tenth aspects, determining the CAPC for the transmission includes: determining a bearer for the transmission to the second UE over the sidelink interface, and determining the CAPC for the transmission based on the bearer for the transmission and a mapping between bearers and CAPCs.

In general, in a twelfth aspect combinable with any of the first through eleventh aspects, the mapping associates sidelink signaling radio bearer 0 (SL-SRB0), SL-SRB1, or SL-SRB4 with a highest priority CAPC.

In general, in a thirteenth aspect combinable with any of the first through twelfth aspects, the mapping associates sidelink signaling radio bearer 2 (SL-SRB2) with a highest priority CAPC or a configured CAPC.

In general, in a fourteenth aspect combinable with any of the first through thirteenth aspects, the transmission is SL-SRB2, SL-SRB3, or sidelink data radio bearer (SL-DRB), and the method includes receiving an indication of the CAPC for the transmission from an access node.

In general, in a fifteenth aspect combinable with any of the first through fourteenth aspects, a bearer for the transmission is SL-SRB2, SL-SRB3, or SL-DRB, and when the transmission includes one or more MAC CEs, a highest priority CAPC among the one or more MAC CEs is used as the CAPC for the transmission.

In general, in a sixteenth aspect combinable with any of the first through fifteenth aspects, a bearer for the transmission is SL-SRB2, SL-SRB3, or SL-DRB, and a highest priority CAPC is used as the CAPC for the transmission when the transmission includes one or more of a SRB0 service data unit (SDU), a SRB1 SDU, a SRB2 SDU, or a SRB4 SDU.

In general, in a seventeenth aspect combinable with any of the first through sixteenth aspects, a bearer for the transmission is SL-SRB2, SL-SRB3, or SL-DRB, and when the transmission includes one or more SL-SRB3 SDUs, a highest priority CAPC among the one or more SL-SRB3 SDUs is used as the CAPC for the transmission.

In general, in an eighteenth aspect combinable with any of the first through seventeenth aspects, determining the CAPC for the transmission includes: determining a logical channel priority for the transmission, and determining the CAPC for the transmission based on the logical channel priority for the transmission and a mapping between sidelink logical channel (SL-LCH) priorities and CAPCs.

In general, in a nineteenth aspect combinable with any of the first through eighteenth aspects, determining the CAPC for the transmission includes: determining a layer 1 priority for the transmission, and determining the CAPC for the transmission based on the layer 1 priority for the transmission and a mapping between layer 1 priorities and CAPCs.

In general, in a twentieth aspect combinable with any of the first through nineteenth aspects, the transmission is a configured grant transmission, and the CAPC for the transmission is determined based on a configured grant configuration index.

In general, in a twenty-first aspect combinable with any of the first through twentieth aspects, the CAPC for the transmission is determined based at least in part on how long data for the transmission has been queued in a buffer, or how much data is queued in the buffer.

In general, in a twenty-second aspect combinable with any of the first through twenty-first aspects, adjusting the CAPC for the transmission to a higher priority CAPC when the transmission is a retransmission.

In general, in a twenty-third aspect combinable with any of the first through twenty-second aspects, the method includes transmitting the transmission to the second UE over the sidelink interface after performing the listen-before-talk procedure based on the determined CAPC.

In general, in a twenty-fourth aspect combinable with any of the first through twenty-third aspects, the transmission includes an indication of the determined CAPC.

In general, in a twenty-fifth aspect combinable with any of the first through twenty-fourth aspects, the method includes receiving, from the second UE, an indication of the CAPC for the transmission.

In general, in a twenty-sixth aspect combinable with any of the first through twenty-fifth aspects, performing the listen-before-talk procedure based on the determined CAPC includes adjusting one or more listen-before-talk parameters based on the determined CAPC.

In general, in an aspect, a non-transitory computer storage medium stores instructions that, when executed by at least one processor, cause the at least one processor to perform any of the first through twenty-sixth aspects.

In general, in an aspect, a system includes at least one processor and at least one storage device storing instructions executable by the at least one processor to cause the at least one processor to perform any of the first through twenty-sixth aspects.

In general, in an aspect, a UE includes at least one processor and at least one storage device storing instructions executable by the at least one processor to cause the at least one processor to perform any of the first through twenty-sixth aspects.

In general, in an aspect, a baseband processor is configured to perform any of the first through twenty-sixth aspects.

### BRIEF DESCRIPTION OF THE FIGURES

FIG. 1 illustrates an example wireless network, according to some implementations.

FIG. 2 illustrates a flowchart for channel access priority class (CAPC) selection for sidelink unlicensed, according to some implementations.

FIG. 3 illustrates an example user equipment (UE), according to some implementations.

FIG. 4 illustrates an example access node, according to some implementations.

Like reference numbers and designations in the various drawings indicate like elements.

### DETAILED DESCRIPTION

One of the areas for study and development in Release 18 of the Third Generation Partnership Project (3GPP) technical standards is a sidelink interface operating in an unlicensed spectrum (also referred to as “sidelink unlicensed”). In particular, the study and development includes channel access mechanisms, sidelink resource reservation procedures, physical channel design frameworks, and sidelink physical channel structures and procedures for sidelink unlicensed. One of the advantages of sidelink unlicensed is the ability to accommodate the continually increasing demand of wireless data traffic. Additionally, sidelink unlicensed can achieve better latency (e.g., quality of service, or QoS) from the perspective of a user equipment (UE) compared to the achievable latency through a Uu interference. Further, some use cases and device types may especially benefit from sidelink unlicensed. Example use cases include home networks, personal networks, industrial networks, etc., and example device types include internet-of-things (IoT) devices, wearable devices, relay devices, etc.

During sidelink communications, a transmitting UE (TX UE) uses a set of allocated sidelink resources to communicate directly with a receiving UE (RX UE). Some wireless communication systems, such as those implemented according to the 3GPP technical standards, support two sidelink resource allocation schemes. In a first scheme, referred to as mode 1 resource allocation (“mode 1”), the sidelink resources are allocated by an access node for in-coverage UEs. In a second scheme, referred to as mode 2 resource allocation (“mode 2”), the transmitting UE selects the sidelink resources from the available sidelink resources (e.g., the sidelink resource pool) without involvement of the access node.

Like other communications over the unlicensed spectrum, sidelink unlicensed uses a listen-before-talk (LBT) procedure to access a channel. During LBT, the TX UE listens to, or senses, a channel to determine whether the channel is free or busy. If the channel is determined to be free, the TX UE can perform the transmission to the RX UE. If no channel is free, the TX UE will wait for a contention window to perform LBT again. To facilitate quality of service (QoS), one or more LBT parameters may be adapted based on a Channel Access Priority Class (CAPC) associated with a transmission. For example, if a transmission is associated with a higher CAPC priority (e.g., a lower CAPC number), one or more LBT parameters, such as the sensing interval, contention window size, and/or channel occupancy time, can be adapted to increase the likelihood of acquiring the channel to perform the transmission.

In New Radio Unlicensed (NR-U), the CAPC for a transmission is specified through a mapping between a 5G QoS indicator (5QI) identifying which QoS class the transmission belongs to and four different CAPCs, as shown in the following table. In addition, the 3GPP technical standards for NR-U specify various rules for determining the CAPC for a transmission, including: the CAPC for signaling radio bearer 0 (SRB0), SRB1 and SRB3 is the highest priority CAPC; the CAPC for SRB2 and data radio bearers (DRBs) is configurable via downlink control information (DCI), the CAPC for medium access control (MAC) control elements (CEs) is the highest priority CAPC, except padding buffer status report (BSR) and codec adaptation (which have the lowest priority CAPC); and if more than one different QoS flow is multiplexed in one DRB, the access node (e.g., gNodeB) considers the 5QIs of all its QoS flows to determine the CAPC.

| CAPC | 5QI |
|---|---|
| 1 | 1, 3, 51, 3, 5, 65, 66, 67, 69, |
| | 70, 79, 80, 82, 83, 84, 85 |
| 2 | 2, 7, 71 |
| 3 | 4, 6, 8, 9, 72, 73, 74, 76 |
| 4 | — |

Currently, a means for determining the CAPC of a transmission over sidelink unlicensed (SL-U) has not been defined in the 3GPP technical standards. Moreover, fundamental differences between SL-U and NR-U, such as the different SRBs and DRBs, the presence of physical sidelink feedback channel (PSFCH), sidelink synchronization signal block (SL-SSB), and other sideline-specific control signaling, as well as that CAPC over sidelink requires bi-directionality (since CAPC is not governed by an access node), make it such that the CAPC selection rules for NR-U and other interfaces cannot be directly applied to SL-U.

The present disclosure describes techniques for CAPC selection for transmissions over sidelink unlicensed. The disclosed techniques are designed to account for features specific to sidelink, and therefore, are different than existing CAPC selection mechanisms (e.g., for interfaces other than sidelink). In some examples, a new mapping is defined that relates a PC5 5QI (PQI) for a sidelink transmission to a CAPC for the transmission. Other mappings to facilitate CAPC selection for sidelink are also defined, including mappings between sidelink logical channel (SL-LCH) priority and CAPC, and between L1 priority and CAPC. Various rules for CAPC selection based on the logical channel for a sidelink transmission, the sidelink bearer (e.g., SL-SRB or SL-DRB) for the transmission, and/or a type of data included in the transmission are also defined.

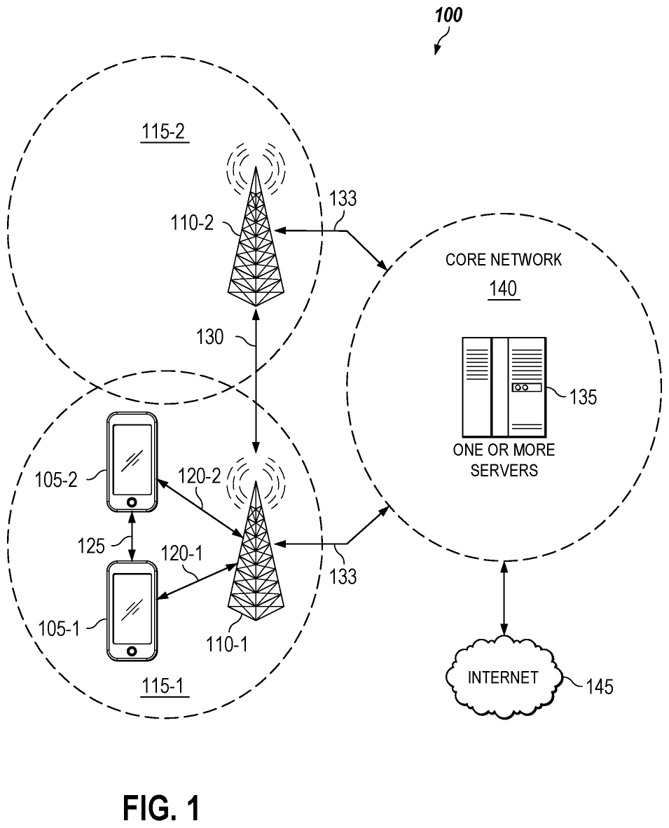

FIG. 1 illustrates an example communication system 100 that includes sidelink communications, according to some implementations. It is noted that the system of FIG. 1 is merely one example of a possible system, and that features of this disclosure may be implemented in other wireless communication systems.

The following description is provided for an example communication system that operates in conjunction with fifth generation (5G) networks as provided by 3GPP technical specifications. However, the example implementations are not limited in this regard and the described examples may apply to other networks that may benefit from the principles described herein, such as 3GPP Long Term Evolution (LTE) networks, Wi-Fi, and the like. Furthermore, other types of communication standards are possible, including future 3GPP systems (e.g., Sixth Generation (6G)). While aspects may be described herein using terminology commonly associated with 5G NR, aspects of the present disclosure can be applied to other systems, such as 3G, 4G, and/or systems subsequent to 5G (e.g., 6G).

As shown, the communication system 100 includes a number of user devices. More specifically, the communication system 100 includes two UEs 105 (UE 105-1 and UE 105-2 are collectively referred to as “UE 105” or “UEs 105”), two base stations 110 (base station 110-1 and base station 110-2 are collectively referred to as “base station 110” or “base stations 110”), two cells 115 (cell 115-1 and cell 115-2 are collectively referred to as “cell 115” or “cells 115”), and one or more servers 135 in a core network (CN) 140 that is connected to the Internet 145.

In some implementations, the UEs 105 can directly communicate with base stations 110 via links 120 (link 120-1 and link 120-2 are collectively referred to as “link 120” or “links 120”), which utilize a direct interface with the base stations referred to as a “Uu interface.” Each of the links 120 can represent one or more channels. The links 120 are illustrated as an air interface to enable communicative coupling, and can be consistent with cellular communications protocols, such as a GSM protocol, a CDMA network protocol, a UMTS protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any of the other communications protocols discussed herein.

As shown, certain user devices may be able to conduct communications with one another directly, e.g., without an intermediary infrastructure device such as base station 110-1. In this example, UE 105-1 may conduct communications directly with UE 105-2. Similarly, the UE 105-2 may conduct communications directly with UE 105-1. Such peer-to-peer communications may utilize a “sidelink” interface such as a PC5 interface. In certain implementations, the PC5 interface supports direct cellular communication between user devices (e.g., between UEs 105), while the Uu interface supports cellular communications with infrastructure devices such as base stations. For example, the UEs 105 may use the PC5 interface for a radio resource control (RRC) signaling exchange between the UEs. The PC5/Uu interfaces are used only as an example, and PC5 as used herein may represent various other possible wireless communications technologies that allow for direct sidelink communications between user devices, while Uu in turn may represent cellular communications conducted between user devices and infrastructure devices, such as base stations.

To transmit/receive data to/from one or more base stations 110 or UEs 105, the UEs 105 may include a transmitter/receiver (or alternatively, a transceiver), memory, one or more processors, and/or other like components that enable the UEs 105 to operate in accordance with one or more wireless communications protocols and/or one or more cellular communications protocols. The UEs 105 may have multiple antenna elements that enable the UEs 105 to maintain multiple links 120 and/or sidelinks 125 to transmit/receive data to/from multiple base stations 110 and/or multiple UEs 105. For example, as shown in FIG. 1, UE 105-1 may connect with base station 110-1 via link 120 and simultaneously connect with UE 105-2 via sidelink 125.

In some implementations, one or more sidelink radio bearers may be established on the sidelink 125. The sidelink radio bearers can include signaling radio bearers (SL-SRB) and/or data radio bearers (SL-DRB). The signaling radio bearers may have different types including SL SRB0, SL-SRB1, SL-SRB2, SL-SRB3, and SL-SRB4.

The PC5 interface may alternatively be referred to as a sidelink interface and may include one or more logical channels, including but not limited to a Physical Sidelink Control Channel (PSCCH), a Physical Sidelink Shared Channel (PSSCH), a Physical Sidelink Discovery Channel (PSDCH), a Physical Sidelink Broadcast Channel (PSBCH), Physical Sidelink Feedback Channel (PSFCH), and/or any other like communications channels. The PSFCH carries feedback related to the successful or failed reception of a sidelink transmission. The PSSCH can be scheduled by sidelink control information (SCI) carried in the sidelink PSCCH. In some examples, the sidelink interface can operate on an unlicensed spectrum (e.g., in the unlicensed 5 Gigahertz (GHz) and 6 GHz bands) or a (licensed) shared spectrum.

In one example, the sidelink interface implements vehicle-to-everything (V2X) communications. The V2X communications may, for example, adhere to 3GPP Cellular V2X (C-V2X) specifications, or to one or more other or subsequent standards whereby vehicles and other devices and network entities may communicate. V2X communications may utilize both long-range (e.g., cellular) communications as well as short- to medium-range (e.g., non-cellular) communications. Cellular-capable V2X communications may be called Cellular V2X (C-V2X) communications. C V2X systems may use various cellular radio access technologies (RATs), such as 4G LTE or 5G NR RATs (or RATs subsequent to 5G, e.g., 6G RATs). Certain LTE standards usable in V2X systems may be called LTE-Vehicle (LTE-V) standards. As used herein in the context of V2X systems, and as defined above, the term “user devices” may refer generally to devices that are associated with mobile actors or traffic participants in the V2X system, e.g., mobile (able-to-move) communication devices such as vehicles, pedestrian user equipment (PUE) devices, and road side units (RSUs).

In some implementations, UEs 105 may be physical hardware devices capable of running one or more applications, capable of accessing network services via one or more radio links 120 with a corresponding base station 110 (also referred to as a “serving” base station), and capable of communicating with one another via sidelink 125. Link 120 may allow the UEs 105 to transmit and receive data from the base station 110 that provides the link 120. The sidelink 125 may allow the UEs 105 to transmit and receive data from one another. The sidelink 125 between the UEs 105 may include one or more channels for transmitting information from UE 105-1 to UE 105-2 and vice versa and/or between UEs 105 and UE-type RSUs and vice versa.

In some implementations, the base stations 110 are capable of communicating with one another over a backhaul connection 130 and may communicate with the one or more servers 135 within the CN 140 over another backhaul connection 133. The backhaul connections can be wired and/or wireless connections.

In some implementations, the UEs 105 are configured to use a resource pool for sidelink communications. A sidelink resource pool may be divided into multiple time slots, frequency channels, and frequency sub-channels. In some examples, the UEs 105 are synchronized and perform sidelink transmissions aligned with slot boundaries. A UE may be expected to select several slots and sub-channels for transmission of the transport block. In some examples, a UE may use different sub-channels for transmission of the transport block across multiple slots within its own resource selection window.

In some implementations, an exceptional resource pool may be configured for the UEs 105, perhaps by the base stations 110. The exceptional resource pool includes resources that the UEs 105 can use in exceptional cases, such as Radio Link Failure (RLF). The exceptional resource pool may include resources selected based on a random allocation of resources.

In some implementations, the communication system 100 supports different cast types, including unicast, broadcast, and groupcast (or multicast) communications. Unicast refers to direction communications between two UEs. Broadcast refers to a communication that is broadcast by a single UE to a plurality of other UEs. Groupcast refers to communications that are sent from a single UE to a set of UEs that satisfy a certain condition (e.g., being a member of a particular group).

In some implementations, a first UE (e.g., the UE 105-1) is configured to perform CAPC selection for a sidelink transmission to a second UE (e.g., the UE 105-2) over the sidelink interface 125. Based on the determined CAPC, the first UE is configured to carry out a listen-before-talk procedure on the sidelink interface 125 (e.g., on a channel of the sidelink interface 125) before transmission to the second UE. For the purposes of this disclosure, a UE that is initiating a communication with another UE is referred to as a TX UE, and the UE receiving the communication is referred to as an RX UE. For example, UE 105-1 may be a TX UE and UE 105-2 may be an RX UE. Further, although FIG. 1 illustrates a single TX UE communicating with a single RX UE, a TX UE may communicate with more than one RX UE via sidelink.

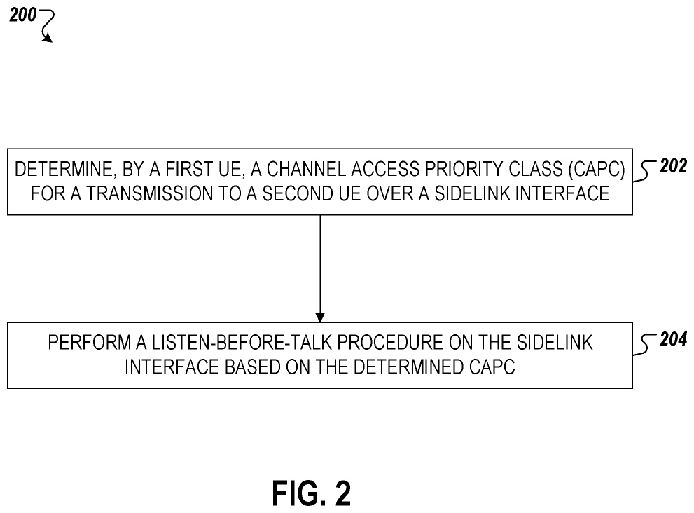

FIG. 2 illustrates a process 200 for CAPC selection, according to some implementations. The process 200 can be implemented by a TX UE that is transmitting (or scheduled to transmit) a sidelink communication to an RX UE. The process 200 can be implemented by a TX UE operating in any RRC state, including idle, inactive, connected, or out-of-coverage, and transmitting to a RX UE. Furthermore, the process 200 can be implemented by a TX UE that is using mode 1 resource allocation scheme or mode 2 resource allocation scheme.

Initially, a TX UE determines to perform a transmission (e.g., a data transmission) to a RX UE over a sidelink interface. The TX UE then determines a CAPC for the transmission to the RX UE over the sidelink interface (202). In some implementations, the CAPC for the transmission is determined based on a mapping between PQIs and CAPCs. The mapping can be defined, for example, by a mapping table that relates PQIs to one of the four CAPCs included in the 3GPP technical standards (and/or other CAPCs). Such a mapping can be specified in the 3GPP technical standards and known to the TX UE and the RX UE.

To determine the CAPC for the transmission based on the mapping, the TX UE can first determine a PQI for the transmission to the RX UE. For example, the TX UE can determine the PQI for the transmission based on a QoS associated with the transmission. If the transmission is associated with a non-standardized QoS, the TX UE can determine a standardized QoS that most closely matches the non-standardized QoS, and use the PQI associated with the standardized QoS as the PQI for the transmission. In some implementations, the TX UE can receive an indication of the PQI for the transmission from, for example, the RX UE or a network node. Once the PQI for the transmission is determined, the TX UE can access the mapping between PQIs and CAPCs and use the mapping to identify the CAPC for the transmission (e.g., by performing a lookup in the mapping using the PQI).

In some examples, the TX UE determines the CAPC for the transmission to the RX UE based on one or more rules or mappings that specify the CAPC based on the logical channel (or logical channel group) for the sidelink transmission, the sidelink bearer (e.g., SL-SRB or SL-DRB) for the transmission, and/or a type of data included in the transmission, among others. For instance, in some implementations, a rule or mapping can specify that transmissions over the PSFCH and/or PSCCH logical channels are associated with a highest priority CAPC, and the TX UE can determine the CAPC for the transmission based on this rule or mapping and a determination that the transmission to the RX UE is a PSFCH or a PSCCH transmission.

In some implementations, a rule or mapping can specify that SL-SRB0, SL-SRB1, and SL-SRB4 are associated with a highest priority CAPC, and the TX UE can determine the CAPC for the transmission based on this rule or mapping and a determination that the transmission to the RX UE uses SL-SRB0, SL-SRB1, or SL-SRB4. In some examples, the rule or mapping can also specify that SL-SRB2 is associated with a highest priority CAPC unless otherwise configured (e.g., by a network node), and the TX UE can determine the CAPC for the transmission based on this rule or mapping and a determination that the transmission to the RX UE uses SL-SRB2.

In some implementations, a rule or mapping can specify that SL-SSB transmissions are associated with a highest priority CAPC, and the TX UE can determine the CAPC for the transmission based on this rule or mapping and a determination that the transmission to the RX UE is a SL-SSB transmission.

In some implementations, a rule or mapping can specify that the CAPC for at least one type of MAC-CE is associated with a highest priority CAPC, a lowest priority CAPC, or a CAPC configured by, for example, a network node. The TX UE can then determine the CAPC for the transmission based on this rule or mapping and a determination that the transmission to the RX UE includes the at least one type of MAC-CE.

In some implementations, a rule or mapping can specify that the CAPC for a padding BSR is associated with a lowest priority CAPC, or that the CAPC depends on the logical channel or logical channel group for the padding BSR. The TX UE can then determine the CAPC for the transmission based on this rule or mapping and a determination that the transmission to the RX UE includes a padding BSR (or based on the logical channel or logical channel group).

In some implementations, a rule or mapping can specify a CAPC for a transmission with SL-SRB3, SL-DRB, or (optionally) SL-SRB2. For example, the rule or mapping can specify that a network node provides the TX UE with the CAPC for the transmission in the sidelink grant (e.g., via DCI 3_0), or in the configured grant (e.g., via RRC). Such a rule may only be applied during mode 1 resource allocation. When the TX UE is operating in mode 2, or the network node does not provide the CAPC in mode 1, the rule or mapping can specify that the TX UE determines the CAPC for the transmission to the RX UE based on the following: if there are only sidelink MAC-CE(s) in the transmission to the RX UE, the highest priority CAPC of these sidelink MAC-CE(s) is used; if SL-SRB0, SL-SRB1, SL-SRB2, or SL-SRB4 SDU(s) are included in the transmission to the RX UE, the highest priority CAPC is used; if SL-SRB3 SDU(s) are included in the transmission to the RX UE, the highest priority CAPC of those SL-SRB3 SDU(s) is used; and the lowest priority, highest priority, or configured CAPC of the logical channels with sidelink MAC SDU multiplexed in the transmission to the RX UE is used otherwise.

In some implementations, the CAPC for the transmission is determined based on a mapping between SL-LCH priorities and CAPCs. The mapping can be defined, for example, by a mapping table that relates SL-LCH priorities to one of the four CAPCs included in the 3GPP technical standards (and/or other CAPCs). Such a mapping can be specified in the 3GPP technical standards and known to the TX UE and the RX UE. In this example, the TX UE can determine the CAPC for the transmission to the RX UE based on the following rules: PSFCH, PSCCH and SL-SSB are associated with a highest priority CAPC; the CAPC for at least one type of MAC-CE is associated with a highest priority CAPC, a lowest priority CAPC, or a CAPC configured by, for example, a network node; a padding BSR is associated with a lowest priority CAPC, or depends on its associated logical channel or logical channel group; for other sidelink transmissions, the TX UE determines a SL-LCH priority for the transmission, and determines the CAPC for the transmission based on the SL-LCH priority and the mapping between SL-LCH priorities and CAPCs.

In some implementations, the CAPC for the transmission is determined based on a mapping between layer 1 priorities and CAPCs. The mapping can be defined, for example, by a mapping table that relates layer 1 priorities to one of the four CAPCs included in the 3GPP technical standards (and/or other CAPCs). Such a mapping can be specified in the 3GPP technical standards and known to the TX UE and the RX UE. In this example, the TX UE can determine the CAPC for the transmission to the RX UE based on the following rules: PSFCH, PSCCH and SL-SSB are associated with a highest priority CAPC; and for other sidelink transmissions, the TX UE determines a layer 1 priority for the transmission (e.g., based on sidelink control information), and determines the CAPC for the transmission based on the layer 1 priority and the mapping between layer 1 priorities and CAPCs.

In some implementations, the TX UE determines the CAPC for the transmission to the RX UE based on the following rules: PSFCH, PSCCH and SL-SSB are associated with a highest priority CAPC; and for configured grant transmissions, the CAPC for the transmission is determined based on an association (e.g., specified in a mapping table or otherwise) between the configured grant configuration index for the transmission and CAPCs.

In some implementations, the TX UE determines the CAPC for the transmission to the RX UE based on the following rules: PSFCH, PSCCH and SL-SSB are associated with a highest priority CAPC; and for data transmissions, the CAPC for the transmission is determined based on factors including how long the data has been queued in a buffer, and/or how much data is queued in the buffer. In some examples, if the transmission is a retransmission (e.g., an autonomous retransmission after configured grant retransmission timer expiration, or a retransmission scheduled by a network node via DCI 3_0), then the TX UE can adjust the CAPC to a higher priority CAPC.

After determining the CAPC for the transmission, the TX UE performs a LBT procedure on the sidelink interface (e.g., a channel of the sidelink interface) based on the determined CAPC (204). In some examples, performing the LBT procedure based on the determined CAPC includes adjusting one or more LBT parameters, such as a sensing interval, a contention window size, and/or a channel occupancy time, based on the CAPC. If LBT fails (e.g., because the channel is not free), the TX UE can retry LBT (or timeout) as specified in the procedure. On the other hand, if LBT is successful (e.g., because the channel is clear), then the TX UE can perform the transmission to the RX UE. In some implementations, the TX UE can include the CAPC in the transmission to the RX UE for use in subsequent processing or transmissions. The RX UE can perform the process 200 when responding or otherwise transmitting to the TX UE.

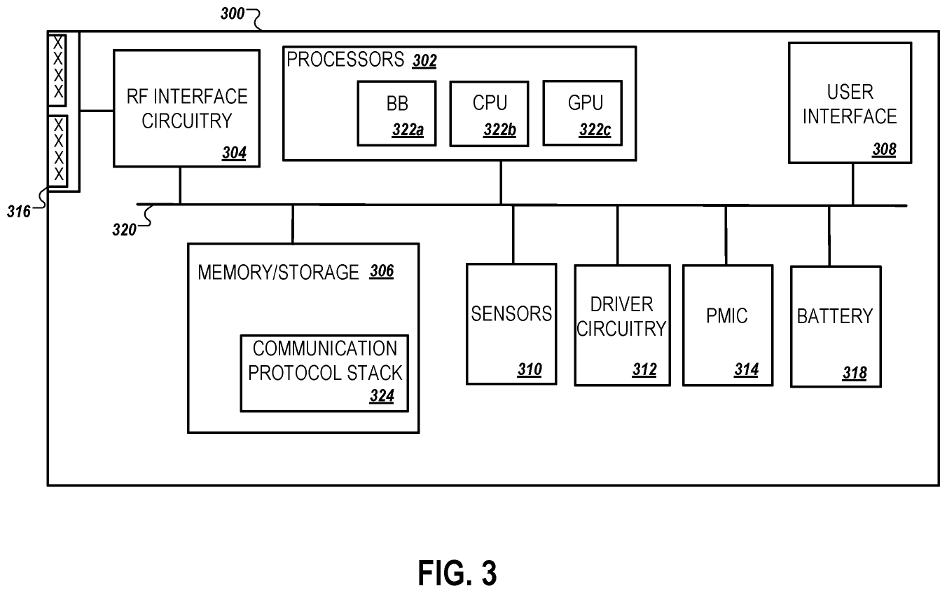

FIG. 3 illustrates a UE 300, in accordance with some embodiments. The UE 300 may be similar to and substantially interchangeable with UE 105 of FIG. 1.

The UE 300 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smart watch), relaxed-IoT devices.

The UE 300 may include processors 302, RF interface circuitry 304, memory/storage 306, user interface 308, sensors 310, driver circuitry 312, power management integrated circuit (PMIC) 314, one or more antennas 316, and battery 318. The components of the UE 300 may be implemented as integrated circuits (ICs), portions thereof, discrete electronic devices, or other modules, logic, hardware, software, firmware, or a combination thereof. The block diagram of FIG. 3 is intended to show a high-level view of some of the components of the UE 300. However, some of the components shown may be omitted, additional components may be present, and different arrangement of the components shown may occur in other implementations.

The components of the UE 300 may be coupled with various other components over one or more interconnects 320, which may represent any type of interface, input/output, bus (local, system, or expansion), transmission line, trace, optical connection, etc. that allows various circuit components (on common or different chips or chipsets) to interact with one another.

The processors 302 may include processor circuitry such as, for example, baseband processor circuitry (BB) 322A, central processor unit circuitry (CPU) 322B, and graphics processor unit circuitry (GPU) 322C. The processors 302 may include any type of circuitry or processor circuitry that executes or otherwise operates computer-executable instructions, such as program code, software modules, or functional processes from memory/storage 306 to cause the UE 300 to perform operations as described herein.

In some implementations, the processors 302 are configured to perform operations that cause the UE to determine a CAPC for a transmission to a second UE over a sidelink channel. Further, the processors 302 are configured to perform operations that cause the UE to carry out a listen-before-talk procedure based on the determined CAPC for the transmission.

In some embodiments, the baseband processor circuitry 322A may access a communication protocol stack 324 in the memory/storage 306 to communicate over a 3GPP compatible network. In general, the baseband processor circuitry 322A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some embodiments, the PHY layer operations may additionally/alternatively be performed by the components of the RF interface circuitry 304. The baseband processor circuitry 322A may generate or process baseband signals or waveforms that carry information in 3GPP-compatible networks. In some embodiments, the waveforms for NR may be based cyclic prefix OFDM “CP-OFDM” in the uplink or downlink, and discrete Fourier transform spread OFDM “DFT-S-OFDM” in the uplink.

The memory/storage 306 may include one or more non-transitory, computer-readable media that includes instructions (for example, communication protocol stack 324) that may be executed by one or more of the processors 302 to cause the UE 300 to perform various operations described herein. The memory/storage 306 include any type of volatile or non-volatile memory that may be distributed throughout the UE 300. In some embodiments, some of the memory/storage 306 may be located on the processors 302 themselves (for example, L1 and L2 cache), while other memory/storage 306 is external to the processors 302 but accessible thereto via a memory interface. The memory/storage 306 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 304 may include transceiver circuitry and radio frequency front module (RFEM) that allows the UE 300 to communicate with other devices over a radio access network. The RF interface circuitry 304 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via one or more antennas 316 and proceed to filter and amplify (with a low-noise amplifier) the signal. The signal may be provided to a receiver of the transceiver that downconverts the RF signal into a baseband signal that is provided to the baseband processor of the processors 302.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the one or more antennas 316. In various embodiments, the RF interface circuitry 304 may be configured to transmit/receive signals in a manner compatible with NR access technologies.

The one or more antennas 316 may include antenna elements to convert electrical signals into radio waves to travel through the air and to convert received radio waves into electrical signals. The antenna elements may be arranged into one or more antenna panels. The one or more antennas 316 may have antenna panels that are omnidirectional, directional, or a combination thereof to enable beamforming and multiple input, multiple output communications. The one or more antennas 316 may include microstrip antennas, printed antennas fabricated on the surface of one or more printed circuit boards, patch antennas, phased array antennas, etc. The one or more antennas 316 may have one or more panels designed for specific frequency bands including bands in FR1 or FR2.

The user interface 308 includes various input/output (I/O) devices designed to enable user interaction with the UE 300. The user interface 308 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 300.

The sensors 310 may include devices, modules, or subsystems whose purpose is to detect events or changes in its environment and send the information (sensor data) about the detected events to some other device, module, subsystem, etc. Examples of such sensors include, inter alia, inertia measurement units include accelerometers, gyroscopes, or magnetometers; microelectromechanical systems or nanoelectromechanical systems including 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 312 may include software and hardware elements that operate to control particular devices that are embedded in the UE 300, attached to the UE 300, or otherwise communicatively coupled with the UE 300. The driver circuitry 312 may include individual drivers allowing other components to interact with or control various input/output (I/O) devices that may be present within, or connected to, the UE 300. For example, driver circuitry 312 may include a display driver to control and allow access to a display device, a touchscreen driver to control and allow access to a touchscreen interface, sensor drivers to obtain sensor readings of sensors 310 and control and allow access to sensors 310, drivers to obtain actuator positions of electro-mechanic components or control and allow access to the electro-mechanic components, a camera driver to control and allow access to an embedded image capture device, audio drivers to control and allow access to one or more audio devices.

The PMIC 314 may manage power provided to various components of the UE 300. In particular, with respect to the processors 302, the PMIC 314 may control power-source selection, voltage scaling, battery charging, or DC-to-DC conversion.

In some embodiments, the PMIC 314 may control, or otherwise be part of, various power saving mechanisms of the UE 300 including DRX as discussed herein. A battery 318 may power the UE 300, although in some examples the UE 300 may be mounted deployed in a fixed location, and may have a power supply coupled to an electrical grid. The battery 318 may be a lithium ion battery, a metal-air battery, such as a zinc-air battery, an aluminum-air battery, a lithium-air battery, and the like. In some implementations, such as in vehicle-based applications, the battery 318 may be a typical lead-acid automotive battery.

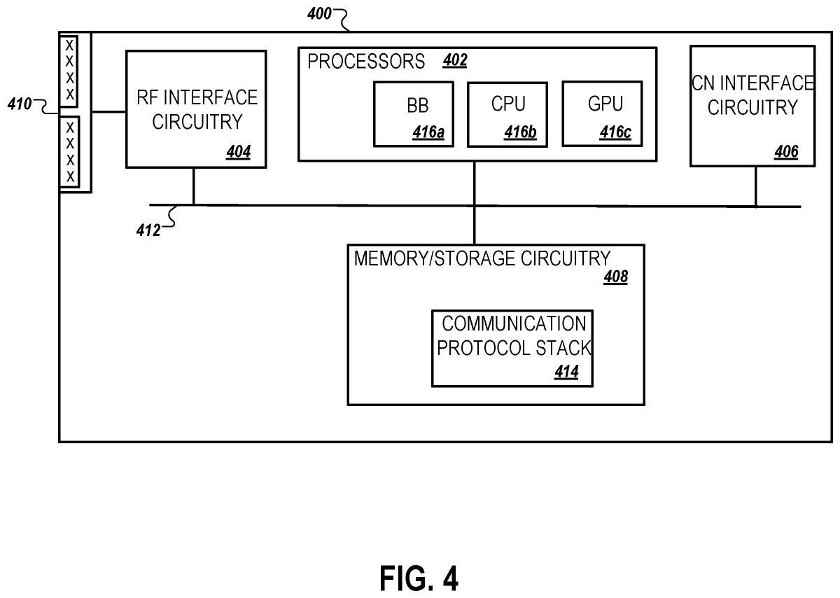

FIG. 4 illustrates an access node 400 (e.g., a base station or gNB), in accordance with some embodiments. The access node 400 may be similar to and substantially interchangeable with base station 110. The access node 400 may include processors 402, RF interface circuitry 404, core network (CN) interface circuitry 406, memory/storage circuitry 408, and one or more antennas 410.

The components of the access node 400 may be coupled with various other components over one or more interconnects 412. The processors 402, RF interface circuitry 404, memory/storage circuitry 408 (including communication protocol stack 414), one or more antennas 410, and interconnects 412 may be similar to like-named elements shown and described with respect to FIG. 3. For example, the processors 402 may include processor circuitry such as, for example, baseband processor circuitry (BB) 416A, central processor unit circuitry (CPU) 416B, and graphics processor unit circuitry (GPU) 416C.

The CN interface circuitry 406 may provide connectivity to a core network, for example, a 5th Generation Core network (5GC) using a 5GC-compatible network interface protocol such as carrier Ethernet protocols, or some other suitable protocol. Network connectivity may be provided to/from the access node 400 via a fiber optic or wireless backhaul. The CN interface circuitry 406 may include one or more dedicated processors or FPGAs to communicate using one or more of the aforementioned protocols. In some implementations, the CN interface circuitry 406 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 400 that operates in an NR or 5G system (for example, a gNB), and the term “E-UTRAN node” or the like may refer to an access node 400 that operates in an LTE or 4G system (e.g., an eNB). According to various embodiments, the access node 400 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some embodiments, all or parts of the access node 400 may be implemented as one or more software entities running on server computers as part of a virtual network, which may be referred to as a CRAN and/or a virtual baseband unit pool (vBBUP). In these embodiments, the CRAN or vBBUP may implement a RAN function split, such as a PDCP split in which RRC and PDCP layers are operated by the CRAN/vBBUP and other L2 protocol entities are operated by the access node 400; a MAC/PHY split in which RRC, PDCP, RLC, and MAC layers are operated by the CRAN/vBBUP and the PHY layer is operated by the access node 400; or a “lower PHY” split in which RRC, PDCP, RLC, MAC layers and upper portions of the PHY layer are operated by the CRAN/vBBUP and lower portions of the PHY layer are operated by the access node 400.

In V2X scenarios, the access node 400 may be or act as RSUs. The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

Example 1 includes one or more processors of a first user equipment (UE), the one or more processors configured to cause the first UE to perform operations including: determining, by the first UE, a channel access priority class (CAPC) for a transmission to a second UE over a sidelink interface; and performing a listen-before-talk procedure on the sidelink interface based on the determined CAPC.

Example 2 is the one or more processors of Example 1, wherein determining the CAPC for the transmission includes: determining a PC5 5QI (PQI) for the transmission to the second UE over the sidelink interface; and determining the CAPC for the transmission based on the PQI for the transmission and a mapping between PQIs and CAPCs.

Example 3 is the one or more processors of Examples 1 or 2, wherein the PQI for the transmission is determined based on a quality of service (QoS) associated with the transmission.

Example 4 is the one or more processors of any of Examples 1 to 3, wherein the transmission is associated with a non-standardized quality of service (QoS), and wherein determining the PQI for the transmission includes: determining a standardized QoS based on the non-standardized QoS; and using a PQI associated with the standardized QoS as the PQI for the transmission.

Example 5 is the one or more processors of any of Examples 1 to 4, wherein determining the CAPC for the transmission includes: determining a sidelink logical channel for the transmission to the second UE over the sidelink interface; and determining the CAPC for the transmission based on the sidelink logical channel for the transmission and a mapping between sidelink logical channels and CAPCs.

Example 6 is the one or more processors of any of Examples 1 to 5, wherein the mapping associates a physical sidelink feedback channel (PSFCH) or a physical sidelink control channel (PSCCH) with a highest priority CAPC.

Example 7 is the one or more processors of any of Examples 1 to 6, wherein determining the CAPC for the transmission includes: determining a type of data included in the transmission to the second UE over the sidelink interface; and determining the CAPC for the transmission based on the type of data included in the transmission and a mapping between types of data transmissions and CAPCs.

Example 8 is the one or more processors of any of Examples 1 to 7, wherein the mapping associates a sidelink synchronization signal block (SL-SSB) with a highest priority CAPC.

Example 9 is the one or more processors of any of Examples 1 to 8, wherein the mapping associates at least one type of medium access control (MAC) control element (CE) with a highest priority CAPC or a lowest priority CAPC.

Example 10 is the one or more processors of any of Examples 1 to 9, wherein the mapping associates a padding buffer status report (BFR) with a lowest priority CAPC.

Example 11 is the one or more processors of any of Examples 1 to 10, wherein determining the CAPC for the transmission includes: determining a bearer for the transmission to the second UE over the sidelink interface; and determining the CAPC for the transmission based on the bearer for the transmission and a mapping between bearers and CAPCs.

Example 12 is the one or more processors of any of Examples 1 to 11, wherein the mapping associates sidelink signaling radio bearer 0 (SL-SRB0), SL-SRB1, or SL-SRB4 with a highest priority CAPC.

Example 13 is the one or more processors of any of Examples 1 to 12, wherein the mapping associates sidelink signaling radio bearer 2 (SL-SRB2) with a highest priority CAPC or a configured CAPC.

Example 14 is the one or more processors of any of Examples 1 to 13, wherein a bearer for the transmission is sidelink signaling radio bearer 2 (SL-SRB2), SL-SRB3, or sidelink data radio bearer (SL-DRB), and wherein the operations further include receiving an indication of the CAPC for the transmission from an access node.

Example 15 is the one or more processors of any of Examples 1 to 14, wherein a bearer for the transmission is sidelink signaling radio bearer 2 (SL-SRB2), SL-SRB3, or sidelink data radio bearer (SL-DRB), and wherein when the transmission includes one or more medium access control (MAC) control elements (CEs), a highest priority CAPC among the one or more MAC CEs is used as the CAPC for the transmission.

Example 16 is the one or more processors of any of Examples 1 to 15, wherein a bearer for the transmission is sidelink signaling radio bearer 2 (SL-SRB2), SL-SRB3, or sidelink data radio bearer (SL-DRB), and wherein a highest priority CAPC is used as the CAPC for the transmission when the transmission includes one or more of a SRB0 service data unit (SDU), a SRB1 SDU, a SRB2 SDU, or a SRB4 SDU.

Example 17 is the one or more processors of any of Examples 1 to 16, wherein a bearer for the transmission is sidelink signaling radio bearer 2 (SL-SRB2), SL-SRB3, or sidelink data radio bearer (SL-DRB), and wherein when the transmission includes one or more SL-SRB3 service data units (SDUs), a highest priority CAPC among the one or more SL-SRB3 SDUs is used as the CAPC for the transmission.

Example 18 is the one or more processors of any of Examples 1 to 17, wherein determining the CAPC for the transmission includes: determining a logical channel priority for the transmission; and determining the CAPC for the transmission based on the logical channel priority for the transmission and a mapping between sidelink logical channel (SL-LCH) priorities and CAPCs.

Example 19 is the one or more processors of any of Examples 1 to 18, wherein determining the CAPC for the transmission includes: determining a layer 1 priority for the transmission; and determining the CAPC for the transmission based on the layer 1 priority for the transmission and a mapping between layer 1 priorities and CAPCs.

Example 20 is the one or more processors of any of Examples 1 to 19, wherein the transmission is a configured grant transmission, and wherein the CAPC for the transmission is determined based on a configured grant configuration index.

Example 21 is the one or more processors of any of Examples 1 to 20, wherein the CAPC for the transmission is determined based at least in part on how long data for the transmission has been queued in a buffer, or how much data is queued in the buffer.

Example 22 is the one or more processors of any of Examples 1 to 21, the operations further including adjusting the CAPC for the transmission to a higher priority CAPC when the transmission includes a retransmission

Example 23 is the one or more processors of any of Examples 1 to 22, the operations further including transmitting the transmission to the second UE over the sidelink interface after performing the listen-before-talk procedure based on the determined CAPC.

Example 24 is the one or more processors of any of Examples 1 to 23, wherein the transmission includes an indication of the determined CAPC.

Example 25 is the one or more processors of any of Examples 1 to 24, the operations further including receiving, from the second UE, an indication of the CAPC for the transmission.

Example 26 is the one or more processors of any of Examples 1 to 25, wherein performing the listen-before-talk procedure based on the determined CAPC includes adjusting one or more listen-before-talk parameters based on the determined CAPC.

Example 27 includes a non-transitory computer storage medium encoded with instructions executable by one or more processors to cause the one or more processors to perform the operations of any of Examples 1 to 26.

Example 28 includes a system including or more processors and memory storing instructions executable by the one or more processors to cause the one or more processors to perform the operations of any of Examples 1 to 26.

Example 29 includes a device including or more processors and memory storing instructions executable by the one or more processors to cause the one or more processors to perform the operations of any of Examples 1 to 26.

Example 30 includes a method for performing the operations of any of Examples 1 to 26.

Example 31 includes a user equipment (UE) including one or more processors and memory storing instructions executable by the one or more processors to cause the one or more processors to perform the operations of any of Examples 1 to 26.

Example 32 includes a system including one or more processors and memory storing instructions executable by the one or more processors to cause the one or more processors to perform the operations of any of Examples 1 to 26.

Example 33 may include an apparatus including logic, modules, or circuitry to perform one or more elements of the operations described in or related to any of Examples 1 to 26, or any other operations or process described herein.

Example 34 may include a method, technique, or process as described in or related to the operations of any of Examples 1 to 26, or portions or parts thereof.

Example 35 may include an apparatus, e.g., a user equipment, including: one or more processors and one or more computer-readable media including instructions that, when executed by the one or more processors, cause the one or more processors to perform the method, techniques, or process as described in or related to the operations of any of Examples 1 to 26, or portions thereof.

Example 36 may include a computer program including instructions, wherein execution of the program by a processing element is to cause the processing element to carry out the method, techniques, or process as described in or related to the operations of any of Examples 1 to 26, or portions thereof. The operations or actions performed by the instructions executed by the processing element can include the operations of any one of Examples 1 to 26.

Example 37 may include a method of communicating in a wireless network as shown and described herein.

Example 38 may include a system for providing wireless communication as shown and described herein. The operations or actions performed by the system can include the operations of any one of Examples 1 to 26.

Example 39 may include a device for providing wireless communication as shown and described herein. The operations or actions performed by the device can include the operations of any one of Examples 1 to 26.

The previously-described operations of Examples 1 to 26 are implementable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

Any of the above-described examples may be combined with any other example (or combination of examples), unless explicitly stated otherwise. The foregoing description of one or more implementations provides illustration and description, but is not intended to be exhaustive or to limit the scope of implementations to the precise form disclosed. Modifications and variations are possible in light of the above teachings or may be acquired from practice of various implementations.

Although the implementations above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. One or more processors configured, when executing instructions stored in memory, to perform operations comprising:
determining a sidelink channel access priority class (SL-CAPC) for a transmission from a first user equipment (UE) to a second UE over a sidelink interface; and
causing radio frequency circuitry to transmit the transmission to the second UE over the sidelink interface based on the determined SL-CAPC.

2. The one or more processors of claim 1, wherein determining the SL-CAPC for the transmission comprises:
determining a PC5 5QI (PQI) for the transmission to the second UE over the sidelink interface; and
determining the SL-CAPC for the transmission based on the PQI for the transmission and a mapping between PQIs and SL-CAPCs.

3. The one or more processors of claim 2, wherein the PQI for the transmission is determined based on a quality of service (QoS) associated with the transmission.

4. The one or more processors of claim 2, wherein the transmission is associated with a non-standardized PQI, and wherein determining the SL-CAPC for the transmission comprises:
determining a standardized POI based on the non-standardized PQI; and
determining the SL-CAPC for the transmission based on the standardized PQI.

5. (canceled)

6. The one or more processors of claim 1, wherein a highest priority SL-CAPC is used as the SL-CAPC for the transmission when the transmission comprises a physical sidelink feedback channel (PSFCH) transmission.

7. (canceled)

8. (canceled)

9. (canceled)

10. (canceled)

11. The one or more processors of claim 1, wherein determining the SL-CAPC for the transmission comprises:
determining a bearer for the transmission to the second UE over the sidelink interface; and
determining the SL-CAPC for the transmission based on the bearer for the transmission and a mapping between bearers and SL-CAPCs.

12. (canceled)

13. (canceled)

14. (canceled)

15. The one or more processors of claim 1, wherein when the transmission comprises a transport block including only one or more medium access control (MAC) control elements (CEs), a highest priority SL-CAPC is used as the SL-CAPC for the transmission.

16. The one or more processors of claim 1, wherein when the transmission comprises a transport block including one or more service data units (SDUs), a highest priority SL-CAPC is used as the SL-CAPC for the transmission.

17. (canceled)

18. The one or more processors of claim 1, wherein determining the SL-CAPC for the transmission comprises:
determining a logical channel priority for the transmission; and
determining the SL-CAPC for the transmission based on the logical channel priority for the transmission and a mapping between sidelink logical channel (SL-LCH) priorities and SL-CAPCs.

19. (canceled)

20. The one or more processors of claim 1, wherein the SL-CAPC for the transmission is configured by a network.

21. The one or more processors of claim 1, wherein the SL-CAPC for the transmission is determined based at least in part on how long data for the transmission has been queued in a buffer, or how much data is queued in the buffer.

22. (canceled)

23. The one or more processors of claim 1, wherein the transmission is part of a listen-before-talk procedure, and wherein the SL-CAPC is determined based in part on the transmission being part of the listen-before-talk procedure.

24. (canceled)

25. (canceled)

26. (canceled)

27. (canceled)

28. (canceled)

29. (canceled)

30. A method, comprising:
determining a sidelink channel access priority class (SL-CAPC) for a transmission from a first user equipment (UE) to a second UE over a sidelink interface; and
causing radio frequency circuitry to transmit the transmission to the second UE over the sidelink interface based on the determined SL-CAPC.

31. The method of claim 30, wherein determining the SL-CAPC for the transmission comprises:
determining a PC5 5QI (PQI) for the transmission to the second UE over the sidelink interface; and
determining the SL-CAPC for the transmission based on the PQI for the transmission and a mapping between PQIs and SL-CAPCs.

32. The method of claim 31, wherein the PQI for the transmission is determined based on a quality of service (QoS) associated with the transmission.

33. The method of claim 31, wherein the transmission is associated with a non-standardized PQI, and wherein determining the SL-CAPC for the transmission comprises:
determining a standardized PQI based on the non-standardized PQI; and
determining the SL-CAPC for the transmission based on the standardized PQI.

34. A first user equipment (UE), comprising:
a memory;
a transceiver; and
a processor coupled to the memory and configured to, when executing instructions stored in the memory, cause the first UE to:
determine a sidelink channel access priority class (SL-CAPC) for a transmission to a second UE over a sidelink interface; and
transmit, using the transceiver, the transmission to the second UE over the sidelink interface based on the determined SL-CAPC.

35. The first UE of claim 34, wherein determining the SL-CAPC for the transmission comprises:
determining a PC5 5QI (PQI) for the transmission to the second UE over the sidelink interface, wherein the PQI for the transmission is determined based on a quality of service (QoS) associated with the transmission; and
determining the SL-CAPC for the transmission based on the PQI for the transmission and a mapping between PQIs and SL-CAPCs.

36. The first UE of claim 35, wherein the transmission is associated with a non-standardized PQI, and wherein determining the SL-CAPC for the transmission comprises:
determining a standardized PQI based on the non-standardized PQI; and
determining the SL-CAPC for the transmission based on the standardized PQI.

37. The one or more processors of claim 1, wherein a lowest priority SL-CAPC of sidelink logical channels with a medium access control (MAC) service data unit (SDU) multiplexed in the transmission is used as the SL-CAPC for the transmission.
